(19) United States
(12) Patent Application Publication
(10) Pub. No.: US 2014/0257863 A1
(43) Pub. Date: Sep. 11, 2014

(54) SYSTEM AND METHOD OF USAGE-BASED INSURANCE WITH LOCATION-ONLY DATA

(71) Applicant: AMERICAN FAMILY MUTUAL INSURANCE COMPANY, Madison, WI (US)

(72) Inventors: James Maastricht, Sun Prairie, WI (US); Jianping Philip Wang, Madison, WI (US); Ronald Scott, Sun Prairie, WI (US); Peter Frey, Sun Prairie, WI (US); Jeremy Scharnick, Sun Prairie, WI (US)

(73) Assignee: American Family Mutual Insurance Company, Madison, WI (US)

(21) Appl. No.: 13/787,106

(22) Filed: Mar. 6, 2013

(51) Int. Cl. G06Q 40/08

(52) U.S. Cl. CPC G06Q 40/08
USPC 705/4

(57) ABSTRACT

Methods and systems for using vehicle-location information to determine vehicle-usage statistics and using the determined vehicle-usage statistics in an assessment of an insurance discount are described in the present disclosure. In an exemplary embodiment, vehicle-usage statistics are determined solely from received location information, without needing to gather additional information.

### BACKGROUND

When an insurance provider offers auto insurance to a driver, the company takes on the risk that the driver might cause more damage than the driver pays in premiums. Providers attempt to balance that risk by charging higher premiums to drivers that are judged to be higher risk. However, the characteristics used to judge a driver's risk may not reveal the true risk of insuring a particular driver. For example, a young driver may be placed in a high-premium category because of inexperience and youth, even though this particular youth practices safe-driving habits that lower the driver's actual risk. For such a driver, it would be beneficial to offer discounts based on his safe-driving habits, rather than generalizations.

Others have attempted to obtain information on driving behavior in an effort to adjust insurance premiums based on actual usage of a vehicle. One example of an attempt at providing “usage-based insurance” is described in several patents assigned to Progressive Casualty Insurance Company of Ohio (“Progressive”), such as U.S. Pat. Nos. 8,090,598 and 8,140,358. U.S. Pat. No. 8,090,598 (the '598 patent), for instance, states it is directed to a system “for recording, storing, calculating, communicating and reviewing one or more operational aspects of a machine” from which “[i]nsurance costs are based, in part, on activities of the machine operator.” (Abstract.) The '598 patent states that “current motor vehicle control and operating systems comprise electronic systems readily adaptable for modification to obtain the desired types of information relevant to determination of the cost of insurance.” (598 patent at 3:50-53.)

The '598 patent accomplishes its monitoring of “activities of the machine operator” by using an “in-vehicle monitoring device” to collect “selected on-board vehicle data” and then “wirelessly transmit” the data to a remote location where insurance costs are calculated based on the monitored “on-board vehicle data.” The “on-board vehicle data” used in the '598 patent and other techniques is gathered from on-board diagnostic (OBD) systems built into the vehicle. Typically, these OBD systems do not report vehicle location data, and typical usage-based insurance techniques do not exclusively use location data for determining driver safety information. The specification of the '598 patent specifically indicates that “mere vehicle location . . . will not provide data particularly relevant to safety of operation.” In Col. 3, lines 50-59 of the '598 patent, it states: “Vehicle tracking systems have been suggested which use communication links with satellite navigation systems for providing information describing a vehicle's location based upon navigation signals. When such positioning information is combined with maps of geographic information in an expert system, vehicle location is ascertainable. Mere vehicle location, though, will not provide data particularly relevant to safety of operation.”

### SUMMARY

The present disclosure describes a system and method by which only “mere vehicle location” is used to provide information used to determine an insurance discount. As indicated in the specification of the Progressive patent cited above, heretofore, such a system and method was not possible. Yet, herein are described a variety of embodiments to accomplish a usage-based insurance system using only location data.

In one embodiment, a method involves receiving data that is indicative of the geographic locations of a vehicle that is associated with an insurance plan. The method also involves calculating usage statistics for vehicle, based only on the location data. The method further involves determining an insurance discount for the insurance account, based on the usage statistics.

In another embodiment, a method for determining usage-based insurance discounts from location-only information involves receiving, at an insurance server, location-only information that indicates the locations that a vehicle occupied at certain times. The method further involves calculating, movement patterns for the vehicle from the location-only information. The method additionally involves recognizing risk events for the vehicle from the calculated movement patterns. The method also involves determining a discount in accordance with how often risk events occur at the vehicle.

The foregoing is a summary and thus by necessity contains simplifications, generalizations and omissions of detail. Consequently, those skilled in the art will appreciate that the summary is illustrative only and is not intended to be in any way limiting. Other aspects, inventive features, and advantages of the devices and/or processes described herein, will become apparent in the detailed description set forth herein and taken in conjunction with the accompanying drawings.

### BRIEF DESCRIPTION OF THE FIGURES

FIG. 1 is a schematic design of a network system in which exemplary embodiments may be used.

FIG. 2 is a schematic design of a network system in which exemplary embodiments may be used.

FIG. 3 is a schematic design of a location-collection system.

FIG. 4 illustrates a wireless network that may be employed in an exemplary embodiment.

FIG. 5 is a flowchart of an example process.

FIG. 6 is a flowchart of an example process.

FIG. 7 is a flowchart of an example process.

FIG. 8 is a flowchart of an example process.

FIGS. 9A-9D illustrate results of an example process.

### DETAILED DESCRIPTION

Referring generally to the Figures, systems and methods are described herein for using vehicle-location information to determine vehicle-usage statistics and using the determined vehicle-usage statistics in an assessment of an insurance discount. In an exemplary embodiment, vehicle-usage statistics are determined from received location information, without needing to gather additional information. The vehicle-usage statistics may be analyzed to assess a driver's risk of causing damage for which the driver's insurance company would be liable. If the analysis indicates that a particular driver has lower risk than other drivers, the low-risk driver's insurance company may offer the driver a discount on their insurance premium or fees.

The following disclosure is divided into two main sections. The first section discusses the devices and systems that can be used in an example embodiment. The second section discusses the techniques and methods involved in an example embodiment. Although the section on example methods references elements from the example system section, this is not intended to imply that the example systems and methods must be used together. Rather, the example methods may be carried out using any suitable system or combination of systems and the described example systems may carry out procedures other than those outlined in the example methods.

### Example Device and System Architecture

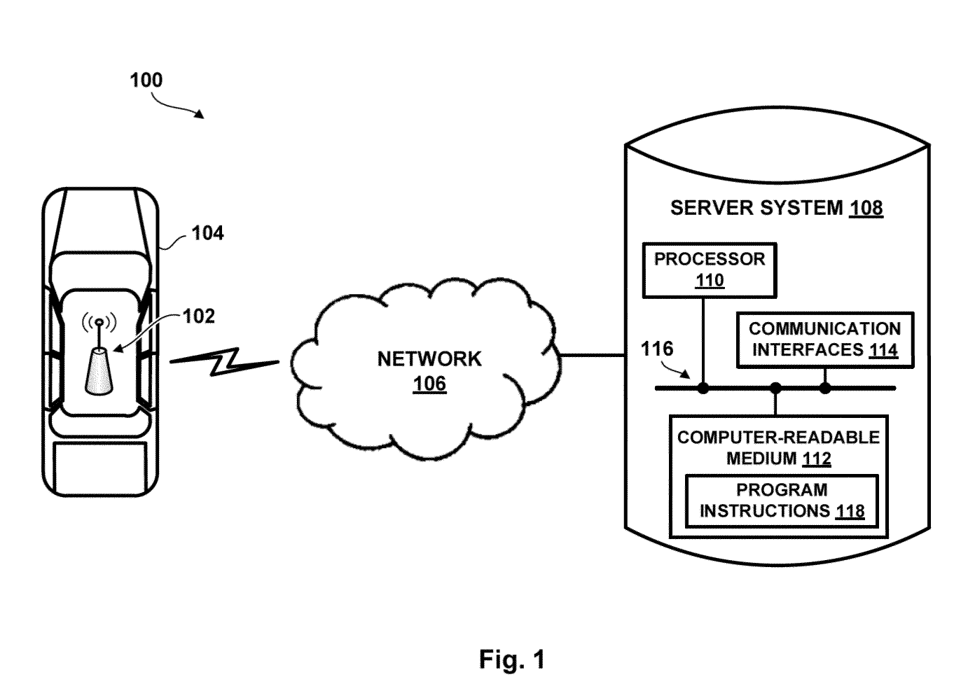

FIG. 1 is a schematic of a network system 100 according to an exemplary embodiment. As shown, system 100 includes a locator device 102 placed at a vehicle 104, a communication network 106, and a server system 108. Server system 108 may communicate with locator device 102 via communication network 106. Also as shown in FIG. 1, server system 108 includes a processor 110, computer-readable medium (CRM) 112, and communication interfaces 114, each coupled to system bus 116. CRM 112 may include a variety of stored data and program instructions, such as program instructions 118, usage history data, and payment account information. Some embodiments may not include all the elements shown in FIG. 1 and/or may include additional elements not shown in the example system of FIG. 1.

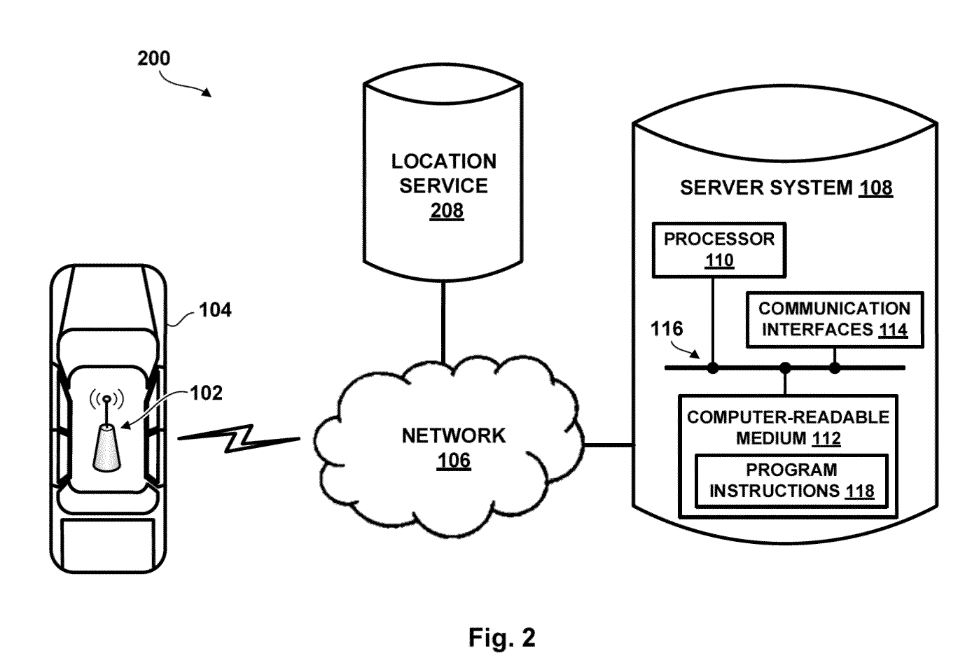

FIG. 2 is a schematic of a network system 200 according to another exemplary embodiment. As shown, system 200 includes a locator device 102 placed in a vehicle 104, a communication network 106, a location service 208, and a server system 108. Also as shown in FIG. 2, server system 108 includes a processor 110, CRM 112, communication interfaces 114, system bus 116, and program instructions 118.

In network system 100 of FIG. 1, locator device 102 may communicate location information directly to server system 108 via communication network 106. In system 200 of FIG. 2, locator device 102 may communicate over communication network 106 with location service 208 and server system 108. In some cases, locator device 102 may transmit location information to location service 208 and, then, location service 208 may transmit the location information to server system 108.

As shown in the Figures, example systems may include computing elements for control and processing. In particular, server system 108 includes processor 110, CRM 112, communication interfaces 114, and system bus 116. CRM 112 may contain program instructions that processor 110 may execute to cause system 100 to perform certain functions. Processor 110 and CRM 112 may be integrally connected in a server or connect locally or remotely to other insurance servers.

Processor 110 may include any processor type capable of executing program instructions 114 in order to perform the functions described herein. For example, processor 110 may be any general-purpose processor, specialized processing unit, or device containing processing elements. In some cases, multiple processing units may be connected and utilized in combination to perform the various functions of processor 110.

CRM 112 may be any available media that can be accessed by processor 110 and any other processing elements in system 100. By way of example, CRM 112 may include RAM, ROM, EPROM, EEPROM, CD-ROM or other optical disk storage, magnetic disk storage or other magnetic storage devices, or any other medium that can be used to carry or store desired program code in the form of program instructions or data structures, and which can be executed by a processor. When information is transferred or provided over a network or another communications connection (either hardwired, wireless, or a combination of hardwired or wireless) to a machine, the machine properly views the connection as a CRM. Thus, any such connection to a computing device or processor is properly termed a CRM. Combinations of the above are also included within the scope of computer-readable media. Program instructions 118 may include, for example, instructions and data capable of causing a processing unit, a general-purpose computer, a special-purpose computer, special-purpose processing machines, or server systems to perform a certain function or group of functions.

In some embodiments, locator device 102, communication network 106, location service 208, and/or other connected devices may include separate processing and storage elements for execution of particular functions associated with each system. In some cases, specific processors and CRM may be dedicated to the control or operation of one system although not integrated into that system. For example, processor 110 may include a locator-control subsystem that uses a special-purpose processing unit to service locator device 102.

Server system 108 also includes communication interfaces 114 for communicating with local and remote systems. Communication interfaces 114 may include, for example, wireless chipsets, antennas, wired ports, signal converters, communication protocols, and other hardware and software for interfacing with external systems. For example, network system 100 may receive data via wired or wireless networks over public or private communication links. As another example, devices in the example systems may receive user-input and user-commands via communication interfaces 114 such as, for instance, remote controllers, touch-screen input, actuation of buttons/switches, voice input, and other user-interface elements.

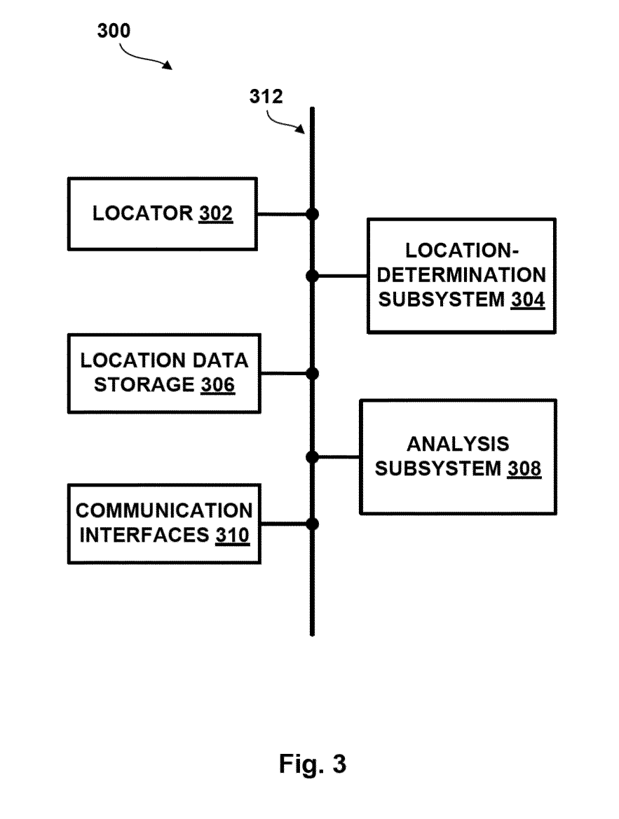

System bus 116 in FIGS. 1 and 2 (along with system bus 312 in FIG. 3) is shown as a single connection for simplicity. However, elements in an exemplary system may connect through a variety of interfaces, communication paths, and networking components. Connections may be wired, wireless, optical, mechanical, or any other connector type. Additionally, some components that are shown as directly connected to through the system bus may actually connect to one another only through some other element on the bus.

I. Collection Device or Service

FIG. 3 is a schematic illustration of an example location-data collection system 300. As shown, collection system 300 includes a locator 302, a location-determination subsystem 304, data storage 306, a data-analysis subsystem 308, and communication interfaces 310, all connected via system bus 312. Locator 302 is located at the location of interest in locator device 102. The other elements may be located in the locator device 102, at location service 208, at server system 108, or split between these systems.

Locator 302 is a device, or set of devices, at the location of interest (e.g., in the vehicle, on the user, etc.). Locator 302 may send out and/or receive wireless signals to facilitate the determination of its current geographic location. For example, locator 302 may receive signals from satellites of a global positioning system (GPS) that are indicative of the location of interest. As another example, locator 302 may send communication signaling to one or more wireless base stations and, in response, receive signals from the base stations that are indicative of the location of locator 302.

In some cases, locator 302 may be wired into a power system of the vehicle. Since the vehicle's power system may not have sufficient resources when the car ignition is turned off, locator 302 may include components for detecting that the cars turned off and, in response, activating a low-power mode. Then, when the vehicle is turned back on, locator 302 may detect this event and responsively switch from the low-power mode to normal operation.

Location-determination subsystem 304 receives data from locator 302 and processes this data to determine the geographical location of interest. In some embodiments, location-determination subsystem 304 may be housed in the same device as locator 302. In other embodiments, location-determination subsystem 304 may be housed in a location service device or server (such as location service 208 of FIG. 2), which connects remotely with locator 302. In still other embodiments, location-determination subsystem 304 may be housed in insurance company servers (such as server system 108), which connects remotely to locator 302. Location-determination subsystem 304 may include processing and computer storage components capable of processing the data from locator 302 to determine a geographical location. In some cases, location-determination subsystem 304 may also determine the time at which locator 302 was at the determined location.

Once location-determination subsystem 304 determines the location indicated by locator 302, this location data may be stored in data storage 306. In some embodiments, data storage for the location data may be included with locator device 102. In such an embodiment, the data may be stored within the locator device 102 until a specified transmission time when the data may be communicated to analysis subsystem 308. Additionally or alternatively, location service 208 may store determined location data. Further, server system 108 may store the determined location data. In some cases, stored location data may indicate each determined location, along with its associated timestamp. In other cases, only specific location data may be saved in data storage 306. For example, only location data associated with movement may be stored. As another example, only location data associated with particular events may be stored. Events of interest will be explained in more detail below.

Before or after the location data is stored in data storage 306, the data may be analyzed by analysis subsystem 308. If analysis subsystem 308 is executed at locator device 102 or location service 208, then the analysis may be performed to determine which portions of the location data to send to insurance servers. Additionally or alternatively, main elements of analysis subsystem 308 may be executed at server system 108, with all available location-data being sent to the server.

Communication interfaces 310 may include any of the features described above with respect to interfaces 114.

II. System Server

As shown in FIG. 1, a server system may include processing, computer-readable storage, and communication elements. Within a computer readable medium, such as CRM 112, program instructions 118 may be stored. Program instructions 118 may be executable by the processing elements, such as processor 110, to perform various functions according to an exemplary embodiment. In addition to program instructions 118, CRM 112 may store various data that may be used in example procedures. For example, CRM 112 may store billing information for insurance plans, historical data related to prior risk assessments, and historical usage data.

Server system 108 may connect to a number of different insurance and other servers. For example, server system 108 may include or connect to billing servers associated with the insurance provider. As another example, server system 108 may connect to banking computers and/or financial-institution servers. Connecting with billing and banking systems may allow server system 108 to automatically apply discounts to an insured driver, as will be described.

Server system may include various computing and networking components. For example, server system may include computers, databases, service nodes, switching systems, cloud-computing systems, routers, and/or wired and wireless data connectors.

III. Communication Network

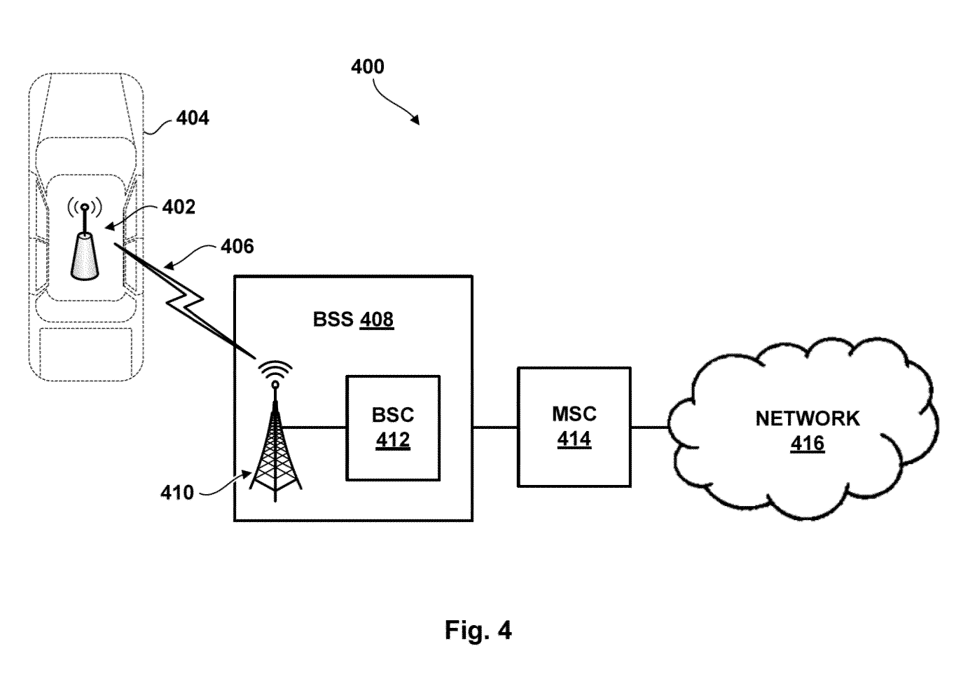

FIG. 4 shows an example network 400 for use in an exemplary embodiment. As shown, network 400 includes a locator device 402 at vehicle 404, which communicates via air interface 406 with a base transceiver station (BTS) 410. BTS 410 is a part of base station subsystem (BSS) 408, along with base station controller (BSC) 412. BSS 408 connects in turn to a mobile switching center 414, which connects to network 416. FIG. 4 shows greatly simplified network system 400. Many additional and alternative features may be used in an actual network to facilitate exemplary embodiments.

Locator device 402, described in more detail above, may connect to BSS 408 by registering with a wireless network associated with BSS 408. Although FIG. 4 shows a single BSS 408 service saying locator device 402, locator device 402 may be serviced by several base stations throughout the course of a given trip. BTS 410 receives and transmits radio signals from and to locator device 402. BSC 412 monitors and controls the transmission between BTS 410 and locator 402. BTS 410 and BSC 412 may use any of various air interface protocols for communicating with locator device 402. Signals received through BSS 408 are forwarded on to MSC 414. MSC 414 may encode the signals into a form that is transmittable across network 416. MSC 414 may include various switching systems, serving nodes, terminals, and connectors to facilitate transmission of data, voice, or other signaling across multiple communication networks. Network 416 may be a single network (for example, the Internet, an intranet, PSTN, PSDN, etc.) or it may be a conglomeration of all the networks that are accessible by MSC 414.

In some embodiments, additional registration signaling may be necessary for connecting through network 416. For example, if locator 402 is part of the wireless phone network, it may need to register with its home location register (HLR) in order to communicate over a packet-switched network. In other embodiments, locator device 402 may use a virtual private network (VPN) to communicate with location service 208 or server system 108. In this case, locator device 402 may need to register with a VPN host or controller before transmitting location data.

### Example Operation

Functions and procedures described in this section may be executed according to any of several embodiments. For example, procedures may be performed by specialized equipment that is designed to perform the particular functions. As another example, the functions may be performed by general-use equipment that executes commands related to the procedures. As still another example, each function may be performed by a different device, with one device or a dedicated controller directing the functions of the different devices. As a further example, procedures may be specified as program instructions on a computer-readable medium.

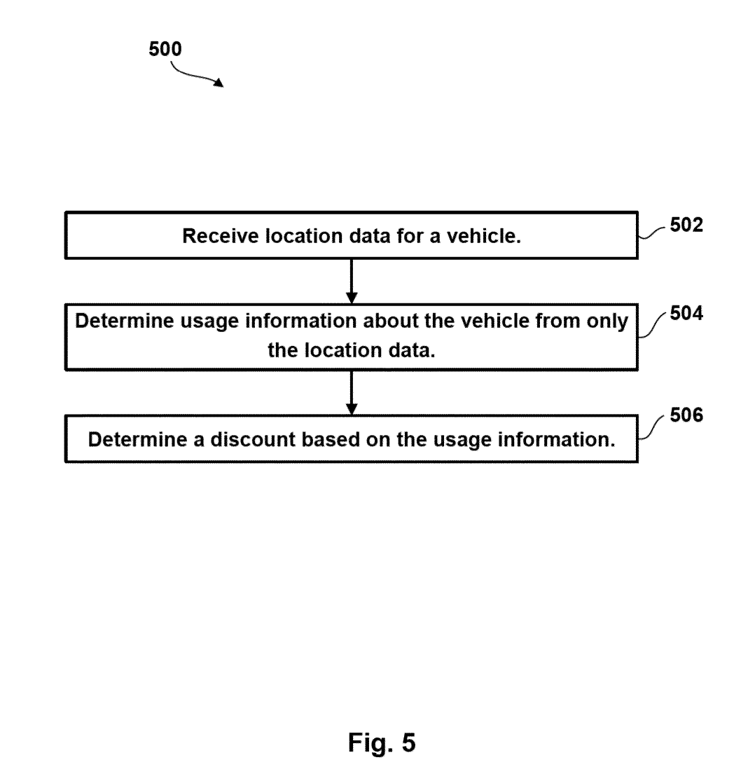

FIG. 5 is a flowchart illustrating a method 500 according to an exemplary embodiment. Additional, fewer, or different steps or operations may be performed depending on the embodiment. As shown, method 500 involves receiving location data for a vehicle (step 502). Method 500 further involves determining usage information about the vehicle from only the location data (step 504). Method 500 further involves determining a discount based on the usage information (step 506).

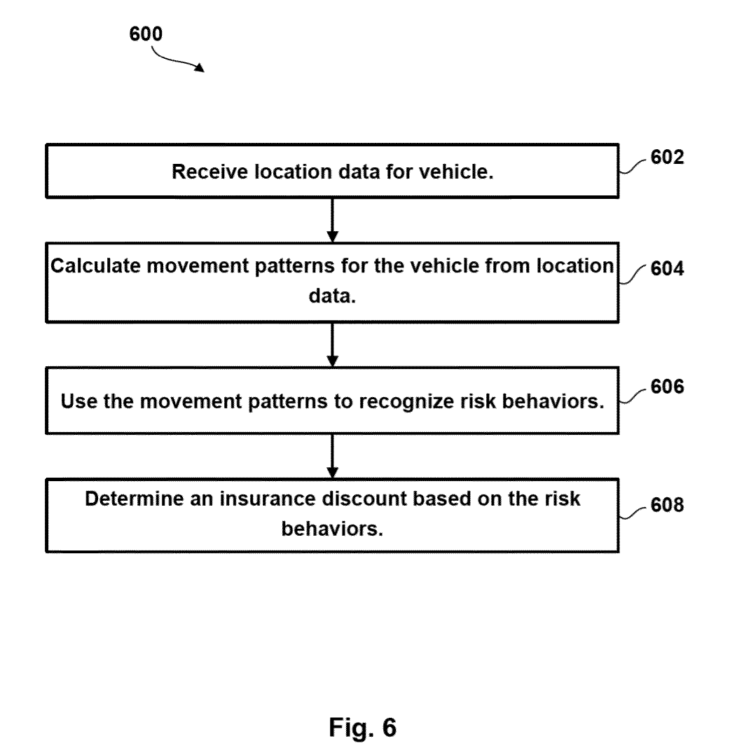

FIG. 6 is a flowchart illustrating another method 600 according to an exemplary embodiment. Additional, fewer, or different steps or operations may be performed depending on the embodiment. As shown, method 600 involves receiving location data for a vehicle (step 602). Method 600 further involves calculating movement patterns for the vehicle from location data (step 604). Method 600 further involves using the movement patterns to recognize risk behaviors (step 606). Method 600 also involves determining an insurance discount based on the risk behaviors (step 608).

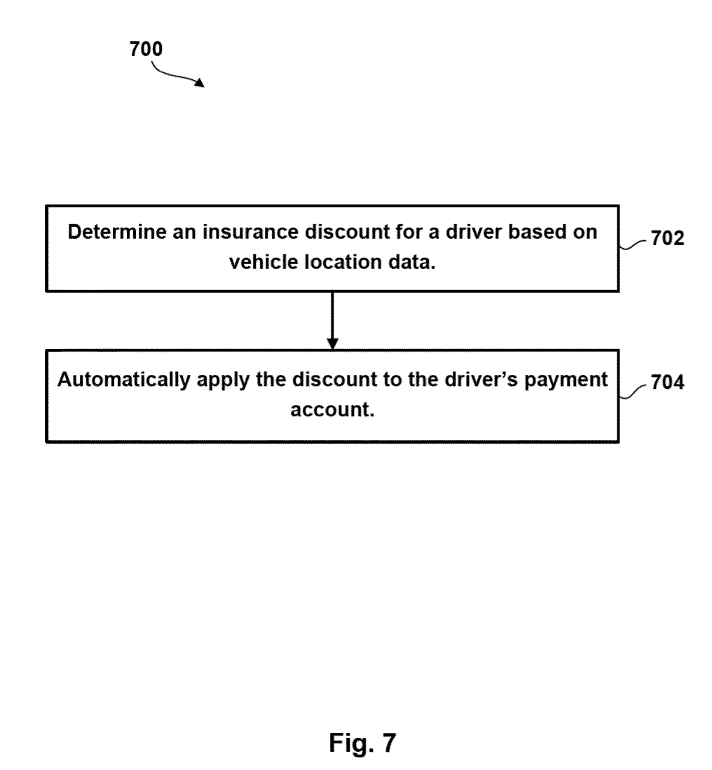

FIG. 7 is a flowchart illustrating still another method 700 according to an exemplary embodiment. Additional, fewer, or different steps or operations may be performed depending on the embodiment. As shown, method 700 involves determining an insurance discount for a driver based on vehicle location data (step 702). Method 700 further involves automatically applying the discount to the driver's payment account (step 704).

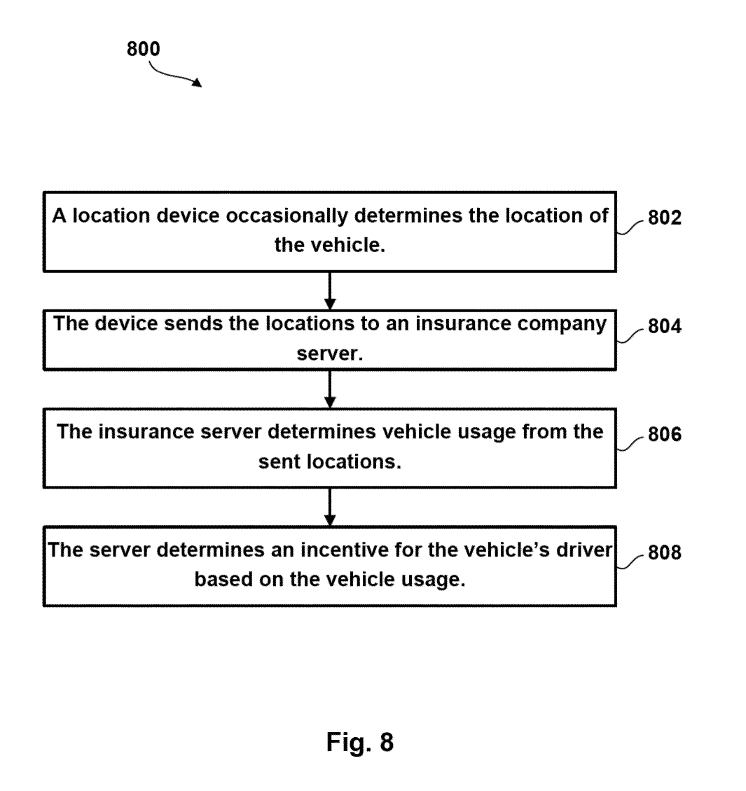

FIG. 8 is a flowchart illustrating a further method 800 according to an exemplary embodiment. Additional, fewer, or different steps or operations may be performed depending on the embodiment. As shown, method 800 involves a location device occasionally determining the location of the vehicle (step 802). Method 800 further involves the device sending the locations to an insurance company server (step 804). Method 800 further involves the insurance server determining vehicle usage from the sent locations (step 806). Method 800 further involves the server determining an incentive for the vehicle's driver based on the vehicle usage (step 808).

Although FIGS. 5-8 show particular steps and order of procedures, exemplary methods may include additional steps, omit shown steps, or reorder the steps in a variety of ways. In the following sections, aspects of each illustrated method, along with other exemplary procedures, are discussed with reference to the systems illustrated in FIGS. 1-4 and the example methods of FIGS. 5-8.

I. Data Collection

An example locator device 102 or location service 208 may collect location data in various ways. In some cases, the location data may be generated based on GPS signaling. For example, locator 102 may receive signals that were sent simultaneously from several GPS satellites and determine, based on when the signals are received by locator 102, the relative distance of each satellite. Locator 102, location service 208, or server 108 may process the satellite-distance data to triangulate locator 102's position at each time.

In other embodiments, the location data may be generated based on wireless network triangulation. In particular, locator device 102 may send out network-probe signals to a wireless network and receive automated response signaling from any nearby base stations. As in the GPS-based technique, the location of device 102 may be triangulated based on signal receipt time or other information sent from the base stations.

In an example embodiment, location data may be generated occasionally. For example, the location data may be generated periodically (e.g., once a second). As another example, the location data may be generated in response to detecting a particular event (e.g., vehicle starts moving, vehicle changes direction, etc.). Once the vehicle's location is determined, the data may be recorded along with a timestamp and stored for analysis. In some cases, the location data may be stored at the locator device. In other cases, the location data may be stored at servers related to location service 208 or insurance server system 108.

In some embodiments, locator 102 or location service 208 may attempt to recognize particular location data that is indicative of non-risk events. For example, if the vehicle is stopped for a certain amount of time, then the location data may not be directly related to any risk behavior. For this reason, location data related to the stable vehicle may be ignored or removed before the location data is sent to the server system. The server system may then fill in missing location information with the same stationary-vehicle data that was removed. Other examples are possible.

II. Requesting and Receiving Location Data

An example server system may make requests for collected location data, and receive that data from, a variety of sources. For example, a server may receive location data directly from a locator device via a wireless network. As another example, the server may receive location data from a locator service that receives the data from the locator device.

Location data may be received in various forms. For example, communication signals representing location data may indicate geographic coordinates of the locator device and a time at which locator occupied those geographical coordinates. As another example, location data may be received as signaling information related to a GPS location technique or a wireless signal triangulation technique. In this implementation, the server system may need to process the received data in order to determine the geographic locations and/or timestamps. In some cases, location data may indicate a time zone of the locator device to facilitate determination of a correct timestamp. In other cases, the time zone of the locator may be inferred by the server from the geographical location. In some implementations, the locator device may transmit other data along with the location data. However, insurance server system 108 may use other received data for purposes not related to usage-based discounts.

In some embodiments, the locator device may store location data to be sent out to the server system. In this way, the locator device may preserve transmission resources by sending batches of stored location data together. For example, at the time that the vehicle is activated for a new trip (e.g., the car's engine is turned on or the battery activated), the locator may send stored location data from a previous trip. In this way, the locator device may only need to establish a communication link one time per trip. In other embodiments, location data may be sent immediately as it is gathered to the server system. For example, if a location service receives data to facilitate driving directions or assistance features, then the received location data may be sent in real time to insurance servers. In still other embodiments, a locator device may send out stored location data periodically (e.g., once a day, once a week, etc.).

In some embodiments, the insurance servers may request location data. For example, the location servers may periodically request location information from the locator device. As another example, insurance servers may contact servers at location service 208 to request stored location information associated with the vehicle. In some cases, the location service may enforce an authorization protocol, in which the insurance servers must verify that they are authorized to receive the requested location data. A driver that is interested in participating in the usage-based discount program, may therefore indicate to the operators of location service 208 that insurance servers 108 are allowed to access location data.

III. Determining Vehicle-Usage Statistics

Once insurance server system 108 has received or generated location data, the server may process this data to determine vehicle usage statistics. For example, step 504 of method 508 and step 806 of method 800 involves determining usage information from location data. The determined usage information may relate to specific risk behaviors. For example, the usage information may indicate amount of time driven in some higher-risk situation (e.g. high speed driving, evening driving, night driving). As another example, the usage information may indicate a number of specific instances of high-risk behaviors (e.g., quick acceleration, hard braking, hard cornering, frequent lane changes, driving on local roads more than highways). As a further example, risk data may be normalized to the amount that the vehicle is used (e.g., number of risk incidents per hour of driving, number of incidents per mile driven). In other cases, the usage information may indicate general driving behaviors that may correlate with risk. For example, the usage information may indicate the total amount of time driven, distance driven, most common driving times, and/or common driving routes.

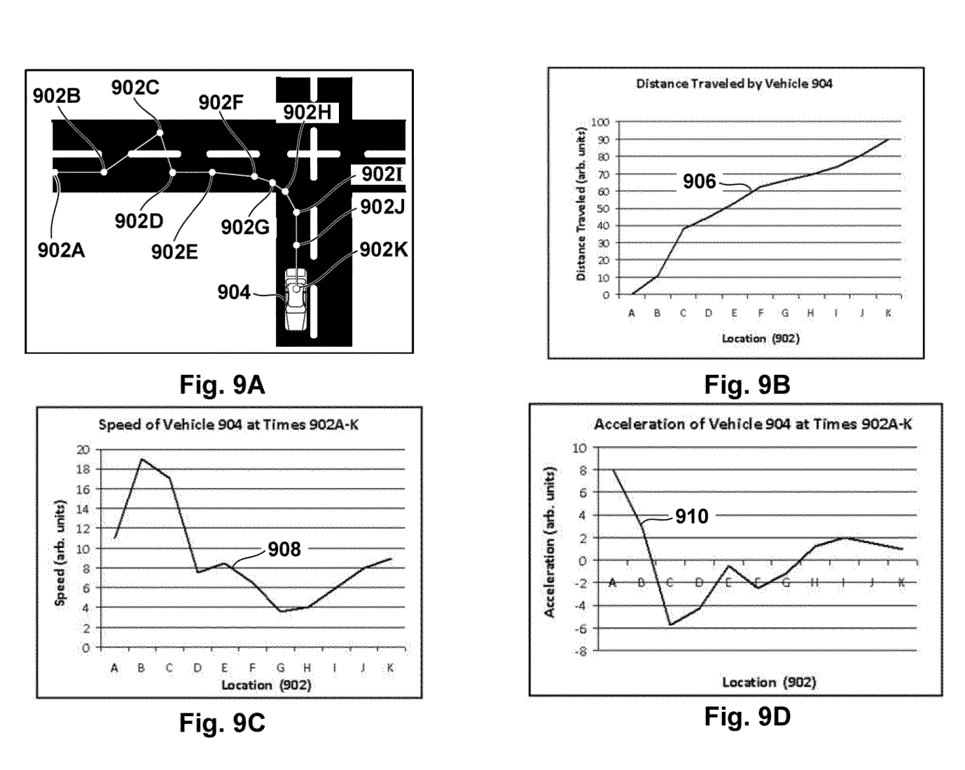

In determining vehicle-usage information, it may be beneficial to convert location data into movement-pattern data. For example, the location information may be converted to distance, speed, direction, acceleration, jerk, or directional change information. FIG. 9A shows an example set of locations (902A-K) for a vehicle turning right. The location data may be converted to distance data simply by summing the distances between each consecutive point. FIG. 9B shows the result of such an algorithm applied to the example situation shown in FIG. 9A. As shown, the total distance traveled by car 904 increases as the car turns the corner.

The speed of the car 904 may be calculated by differentiating distance function 906. Because the movement of car 904 is gathered from empirical data rather than a mathematical function, this differentiation may be accomplished by numerical differentiation means. As one example, the speed of vehicle 904 may be estimated as the distance traveled between successive location determinations divided by the time elapsed between determinations. In some cases, a sophisticated algorithm may be used to determine the speed as a collection of several timesteps worth of data. For example, to determine the speed at the time associated with position 902F of FIG. 9A, an example system may add the distance traveled between 902E and 902F to the distance traveled between 902F and 902G and divide the result by twice the elapsed time between timesteps. Calculated speed 908 of FIG. 9C is an example result of using this algorithm to calculate speed for the situation 900. As another example, the system may calculate car 904's speed at position 902F by summing the distances traveled over each of the times between timestamp 902D and 902H. In such a system, certain data may provide more useful information than other location data. For example, in calculating the speed around point 902F, the numerical differentiation algorithm may tailor the calculation such that the distances closest point to 902F make more of an impact on the determined speed than the distances farther from position 902F. In some cases, location data may be subtracted rather than added to the calculation to help isolate the instantaneous speed independent of other speed information.

The number of data points that are used in a numerical differentiation algorithm may be considered a calculation window. In this way, an algorithm that uses more than one location datum is analogous to a moving-window algorithm. In at least one embodiment, the moving-window may cover five points of location data. In another embodiment, the differentiation may cover seven data points. Other examples are possible.

In some cases, location data may be much noisier than needed for an accurate speed/acceleration calculation. Various methods may be used to correct for this problem. For example, a system may fit the data to a smooth curve using polynomial regression. As another example, moving-window calculations may be used on the points to prevent propagation of noise.

The determination of movement data from location data is not a trivial matter. Systems that use acceleration and speed data directly from a vehicle computer would not be operable to determine movement patterns from location-only information. As one issue, the acceleration data that is derived from location data may have a significantly higher noise-to-signal ratio than that of acceleration data taken from the vehicle's OBD system. Additionally, location data is not necessarily generated as often as OBD data is generated. Further, the numerical differentiation of noisy data may exacerbate the noise problem by emphasizing the quick changes that are often associated with erroneous data.

In some exemplary embodiments, a processing algorithm may detect location data that appears erroneous and remove or replace that data. As an illustration, the location associated with point 902C of FIG. 9A appears to be significantly different from the movement pattern indicated by the surrounding locations. Even with the three-point average used in the calculation of datasets 908 and 910, the inclusion of the location data associated with position 902C creates significant outliers in the speed and acceleration data near that point. In some cases, a system may store predefined thresholds for results, compare all data to the predefined thresholds, and treat any points that surpass the threshold as erroneous. For example, a system may reject speed data that is indicative of an acceleration greater than ±1 g (˜9.8 m/s²). As another example, the system may ignore distance data that is indicative of a speed greater than 120 miles per hour. These numbers and examples are merely exemplary, and other thresholds may be used. In other cases, the system may use other criteria for recognizing erroneous data. For example, location information with large, random changes in direction may be recognized as erroneous data. As another example, sudden and uncontinued movements (e.g., a sudden acceleration at a single location reading followed by a quick deceleration at the next location) may be indicative of erroneous data.

In an example embodiment, once the system determines one or more datapoints to be outliers (e.g., data point 902C) the system may remove the erroneous point from the data. In removing the outlier, the system may leave a place-holding point to indicate that a point was there, but was erroneous. In this way, the differentiation algorithm may ignore this data point from calculation, using the non-erroneous data to calculate the movement information and using the placeholder to relate the movement to correct timestamps. In other embodiments, the system may replace the outlier with a value that fits better with the general trends around the point. For example, the system may perform polynomial regression (e.g., linear regression, quadratic regression, etc.) around the point to interpolate the new value. In some implementations, the system may track the number of datapoints that have been removed or replaced for erroneous results. If the system reaches some threshold amount of errors (e.g., a high ratio of erroneous to correct data, a high frequency of errors, too many errors in a certain set of data), then the system may label all of the data in the group as potentially erroneous and save only the information that is not dependent on correct location information (e.g., trip duration, time of day of driving, etc.). In some cases, a single erroneous datapoint may be sufficient to indicate that the system should skip all calculations that include this datapoint. In still other cases, the system may perform the calculations as usual and, then, remove any risk behavior data that results from erroneous data.

Once speed data, like the data illustrated in FIG. 9C, has been calculated, the system may determine acceleration data by performing a second numerical-differentiation process to the calculated speed data. FIG. 9D shows the results 910 of numerically differentiating speed results 908. In addition to the acceleration magnitude data 910, acceleration data may also include a direction of acceleration. As described above with respect to determining speed data, numerical differentiation may involve comparing, smoothing, averaging, and otherwise processing several speed and distance data points (e.g., one point before and one point after the point of interest (POI), two points before and after the POI and the POI itself, ten points around the POI, etc.). Also as described with respect to determining speed from location data, one or more points of speed data may be removed from consideration or replaced with fit-data to avoid spurious results from the noisy data.

Direction data may be calculated by decomposing each distance traveled into a distance traveled in one or two cardinal directions. For example, the distance traveled between position 902D and position 902E may be 15 feet east, with no component in the north/south direction. As another example, the distance traveled between position 902G and position 902H may be 3 feet east, 2 feet south. In some cases, the direction data may be converted into circular coordinates instead of the Cartesian cardinal directions. As with determining speed information and acceleration information, changes in direction may be calculated by numerically differentiating the direction of travel over one or more successive time periods.

While cornering can be detected by sideways acceleration using an accelerometer, the result may also be calculated in a location-only technique. In such a technique, the cornering acceleration may be calculated from the speed (derived from location data as described above) and the change in direction of travel (derived by comparing the movement directions around the point of interest). In some embodiments, several changes in movement direction may be considered jointly (as with the five-point differentiation technique) with certain movement direction being utilized to determine centripetal acceleration of the turning motion at each point. In other cases, the data may be fit to a polynomial curve (e.g., using polynomial regression) to produce an effective movement pattern with a centripetal acceleration at each point. For example, based on the radius of turning (“r”) and the speed of the vehicle (“v”), the system may determine the centripetal acceleration (“a”) of a turning motion as: a=v²/r. As another example, based on the angular velocity (“ω”) and the speed of the vehicle (“v”), the system may determine the centripetal acceleration (“a”) as: a=ω*v. The system may compare the calculated acceleration of the cornering to a predefined non-zero threshold acceleration and, if the calculated acceleration is greater than the threshold level, reporting a “hard cornering” event.

In addition to movement data, a system may process location data to determine other driving habits. In particular, the system may be able to determine the time spent driving at certain times of the day and in certain situations. For example, by comparing timestamps recorded at the beginning and end of a trip the system may calculate the duration of the trip that took place during predefined hours labeled as late-night hours. As another example, the system may determine whether the vehicle is being operated on local roads or in highway conditions. The determination of local driving may be accomplished by comparing a driver speed to a certain threshold speed, with faster speeds indicating highway driving and slower speeds indicating local driving. Alternatively, local or highway driving may be determined by comparing the vehicle's location to roadmap information. Further, the system may receive additional data related to the driving conditions (e.g., traffic data, weather data, road conditions) and correlate this data with the location data to determine risk situations (e.g., driving duration in heavy traffic, instances of driving during dangerous weather, driving on poorly maintained roads). In some cases, location-based movement data (speed, acceleration, etc.) and location-based driving condition data (weather, road conditions, speed limits) may be processed to yield combined data (driving faster than weather conditions permit, exceeding posted speed limits, accelerating too quickly for road conditions, etc.).

From the general usage statistics, certain risk behaviors may be identified. For example, hard braking, fast acceleration, high speed, hard cornering, high driving duration, and late-night driving. As described above, hard braking, fast acceleration, high speed, and hard cornering may be determined based on certain threshold values of speed, acceleration, and/or directional changes. In some cases, instances of fast acceleration, hard braking, and hard cornering may be identified and stored as counts of discrete risk events. In other cases, the system may determine a duration of time that the driver spent engaging in these risk behaviors. In still other cases, the severity of a risk event may be used to assign a point value to a detected risk event, and the point totals may be used to distinguish between different drivers.

IV. Determining a Driver-Score

Based on the determined vehicle-usage statistics, an insurance company may assign one or more scores to a driver associated with the vehicle. For example, step 606 of method 600 involves analyzing usage statistics to recognize risk behaviors. In an exemplary embodiment, the one or more scores may represent the risk that the driver presents to an insurer. As described above, risk behaviors such as hard braking, fast acceleration, high speed, high driving duration, and late-night driving may indicate that an insurer faces additional risk by insuring the driver.

Actuarial data may be used to assess the relative importance of each risk. For example, driving at night may be more dangerous than driving during the daytime. But high-speed daytime driving may be more dangerous than regular-speed driving at night. In this case, a system may consider both late-night driving time and high-speed driving time to assess risk, and the high-speed driving may be more heavily weighted in calculating the overall risk. In some cases, different risk behaviors may correlate to each other. For example, a driver who spends a large amount of time quickly accelerating may also spend more time engaging in high-speed driving. As another example, a driver who has a greater amount of driving overall may also have a greater amount of nighttime driving. For this reason, several risk behaviors may be mathematically combined into composite score, so that a single score may better predict how the driver's behaviors are indicative of a constructed trait that is linked to higher risk driving. In some implementations, principle component analysis (PCA) may be used to analyze driving data to produce one or more driver scores, representing the risk associated with the driver.

In an exemplary embodiment, each driver or vehicle may be assessed based on the same set of factors. If the particular value of a factor is zero for the driver, that zero data may still be used in assessing risk and assigning a safe-driving score.

In some embodiments, each risk behavior may be treated separately, with each behavior being assigned a particular score based on the location data and with each behavior producing a separate usage-based discount.

V. Determining an Insurance Discount

Based on the overall risk assessment, insurance servers may determine a discount that may be offered to the drivers associated with the vehicle. For example steps 506 of method 500, 608 of method 600, and 808 of method 800 involves determining an insurance discount based on usage statistics representing risk behaviors. Generally, a driver who is assessed to have a lower risk would be offered a larger usage-based discount. In particular, the safer that a driver is (i.e., the fewer risk behaviors the driver exhibits), the higher the safety score, and the larger the discount assessed. In other cases, the score may rise in response to risk behaviors, and the discount may be inversely related to the score.

In some embodiments, a discount may be a particular value that increases as a function of the driver's safety score. In some cases, the discount may stop increasing when the discount reaches a threshold maximum discount amount. In some embodiments, the discount may also have a minimum discount amount. For instance, the minimum discount may be zero, to ensure that customers do not have to pay any surcharge based on their usage. Alternatively, the minimum discount may be positive (i.e., a minimum discount) or negative (i.e., a maximum surcharge). In order to determine the discount amount, the system may look-up the driver's one or more scores in a table relating scores to discount values and output the discount associated with each of the scores (a process known as mapping). In other implementations, the scores may be mapped to discount values by way of a mathematical function, with each score being an input to the function discount values associated with the scores being outputs of the function.

In some exemplary embodiments, the discount may relate to the insurance premium associated with the driver's insurance plan. For example, a discount may be a percentage that the driver's premium deceases as a function of the driver's safety. In such a case, the driver's score may be mapped to a percentage discount and the percentage may then be multiplied by the premium associated with the driver's account to yield the discount amount. In the percentage example, the algorithm may have a maximum discount percentage, representing the best usage-based discount that a driver can receive and, in some cases, reserved for the drivers that exhibit the least risky driving behavior. Other discounting functions may be used to calculate a usage-based discount from driving data and/or scores.

VI. Applying an Insurance Discount

Once an insurance discount is determined, the insurance servers may apply the discount to the insurance account associated with the vehicle. In some cases, the applying may be performed automatically, with the server performing the functions necessary to apply the discount in response to determining that the driver qualifies for the discount.

In some embodiments, applying the determined discount may involve depositing the discount directly into a user's account. In order to automatically apply the discount in this way, insurance server system 108 may connect to a payment processing server or a bank system. For example, an insurance provider that automatically withdraws insurance premium payments from the user's bank account may use the same routing information to deposit the discount amount.

In some embodiments, applying the determined discount may involve lowering a subsequent premium payment. For example, insurance server 108 may communicate with an insurance-billing server to instruct the billing server to apply the discount to a subsequent bill.

### CONCLUSION

The construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in structures, values of parameters, mounting arrangements, orientations, particular variables, etc.) without materially departing from the novel teachings and advantages of the subject matter recited. For example, elements shown as singular may be constructed of multiple parts or elements. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner. Accordingly, all such modifications are intended to be included within the scope of the present disclosure. The order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes, and omissions may be made in the design, operating conditions, and arrangement of the preferred and other exemplary embodiments without departing from scope of the present disclosure or from the scope of the appended claims.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

1. A method comprising:
receiving location data indicative of geographic locations of a vehicle at certain times, wherein the vehicle is associated with an auto insurance plan;
calculating, based only on the location data, usage statistics for the vehicle; and
determining an insurance discount based on the calculated usage statistics.

2. The method of claim 1, further comprising automatically applying the determined insurance discount to a payment account associated with the auto insurance plan.

3. The method of claim 1, wherein the usage statistics comprise: (a) hard braking, (b) fast acceleration, (c) high speed, (d) driving amount, and (e) late-night driving.

4. The method of claim 1, wherein calculating the usage statistics comprises:
determining vehicle speed at each of several times based only on the location data;
recognizing a particular determined vehicle speed as indicative of erroneous location data; and
in response to recognizing the particular vehicle speed as erroneous, removing the particular vehicle speed from the determined vehicle speeds prior to the determination of the insurance discount.

5. The method of claim 4, further comprising:
using polynomial regression to determine an expected value for vehicle speed at the time of the particular vehicle speed; and
using the determined expected value for vehicle speed in place of the removed particular vehicle speed.

6. The method of claim 4, wherein recognizing the particular determined vehicle speed as indicative of erroneous location data comprises recognizing data indicative of sudden and uncontinued motion of the vehicle.

7. The method of claim 1, wherein the location data is received, via a wireless phone network, from a device affixed to the vehicle.

8. A method for determining usage-based insurance discounts from location-only information, the method comprising:
an insurance server system receiving location-only information indicative of a series of geographic locations that a vehicle occupied at a series of corresponding times;
the insurance server system calculating, from the location-only information, a series of speed and acceleration values for the vehicle during at least one of the series of corresponding times;
the insurance server system recognizing, in the calculated series of speed and acceleration values, one or more risk events associated with the vehicle, wherein the insurance server system calculates the series of speed and acceleration values and recognizes the one or more risk events from the location-only information alone without gathering additional vehicle-usage information; and
the insurance server system automatically determining the usage-based insurance discounts in accordance with a relative frequency of the recognized risk events associated with the vehicle.

9. The method of claim 8, wherein the series of speed values is calculated using numerical differentiation techniques on the location-only data, and wherein the series of acceleration values is calculated using numerical differentiation techniques on the series of velocity values.

10. The method of claim 9, wherein the numerical differentiation comprises a moving-window average, and wherein the moving window average uses five location datapoints for differentiation.

11. The method of claim 9, wherein calculating the series of speed and acceleration values comprises:
the insurance server system making a determination that at least a portion of the location data represents erroneous data; and
in response to the determination, the insurance server system ignoring the erroneous data.

12. The method of claim 11, further comprising:
after ignoring the erroneous data, the insurance server system using only the location information to determine (a) an angular velocity for a turning action of the vehicle and (b) a vehicle-speed for the turning action;
the insurance server system calculating a cornering acceleration for the turning action;
the insurance server system making a determination as to whether the calculated cornering acceleration surpasses a predefined non-zero threshold acceleration; and
in response to the determination being that the cornering acceleration surpasses the threshold acceleration, the insurance server system recording the turning action as a risk event for use in determining the insurance discount.

13. The method of claim 8, further comprising automatically applying the determined usage-based insurance discounts.

14. The method of claim 8, further comprising:
the insurance server system receiving driving-condition data indicative of driving conditions at the series of geographic locations; and
the insurance server system determining the usage-based insurance discounts based on the driving-condition data.

15. A non-transitory computer readable medium having stored thereon program instructions executable by a processor to cause an insurance server to:
receive location-only data indicative of geographic locations of a vehicle at certain times, wherein the vehicle is associated with an auto insurance plan;
calculate, based only on the location-only data, usage statistics, comprising a series of speed and acceleration values for the vehicle during at least one of the series of corresponding times, wherein the series of speed and acceleration values are calculated from the location-only information alone without gathering additional vehicle-usage information; and
determine an insurance discount for the auto insurance plan based on the calculated series of speed and acceleration values.

16. The computer readable medium of claim 15, wherein the usage statistics comprise information indicative of: (a) hard braking, (b) fast acceleration, (c) high speed, (d) driving amount, and (e) late night driving.

17. (canceled)

18. The computer readable medium of claim 16, wherein the series of speed values is calculated using numerical differentiation techniques on the location-only data, and wherein the series of acceleration values is calculated using numerical differentiation techniques on the series of velocity values.

19. The computer readable medium of claim 18, wherein the numerical differentiation comprises a moving-window algorithm, and wherein the moving window algorithm uses five location datapoints.

20. The computer readable medium of claim 16, wherein calculating the series of speed and acceleration values comprises:
making a determination that at least a portion of the location-only data represents erroneous data; and
in response to the determination, ignoring the erroneous data.

21. The method of claim 8, wherein the insurance server system determines the usage-based insurance discounts without gathering any vehicle-usage information other than the location-only information.
